(19) United States
(12) Patent Application Publication
(10) Pub. No.: US 2018/0039740 A1
(43) Pub. Date: Feb. 8, 2018

(54) MANAGING ALERTS IN A PATIENT TREATMENT MANAGEMENT SYSTEM

(71) Applicant: ASHBEC, LLC, BLOOMFIELD HILLS, MI (US)

(72) Inventor: W. Vaughn Frick, Bloomfield Hills, MI (US)

(21) Appl. No.: 15/666,640

(22) Filed: Aug. 2, 2017

Related U.S. Application Data
(60) Provisional application No. 62/369,779, filed on Aug. 2, 2016.

(51) Int. Cl. G06F 19/00; G08B 29/18

(52) U.S. Cl. CPC G06F 19/325; G08B 29/185

(57) ABSTRACT

A method and system manages alerts a patient treatment management system to provide continuous process improvement. The method selects one-by-one each step in the treatment regimen for which alerts are being created and/or modified. The method defines a “step not completed” alert for the current regimen step and identifies any other needed alerts. The method determines whether the event represented by the alert endangers the patient or causes an adverse outcome. If “Yes”, the method indicates that there is no automatic suspension of the alert and indicates the “minimal” recipients for the alert. The method processes triggered alerts by determining whether the alert frequency for this alert type has been exceeded or the maximum number of outstanding alerts for this healthcare worker has been exceeded whereby the method notifies the system administrator of the alert overload. If an alert is suspended, information associated with the alert is recorded.

### CROSS-REFERENCE TO RELATED APPLICATIONS

This application claims the benefit of U.S. provisional patent application Ser. No. 62/369,779 filed Aug. 2, 2016.

### FIELD OF THE INVENTION

This invention relates to a method and a system that will allow the effective use of alerts in a patient treatment management system. The described approach will minimize alert fatigue and facilitate dramatic quality increases in treatment delivery.

### BACKGROUND OF THE INVENTION

This section provides background information related to the present disclosure which is not necessarily prior art.

The following analysis clears up some misconceptions about alerts in a patient treatment management system. In particular it debunks the notion that you can build a patient treatment management system that does not use alerts. It then describes a method and system that will allow the effective use of alerts in a patient treatment management system. The described approach will minimize alert fatigue and facilitate dramatic quality increases in treatment delivery.

What is an alert? The common understanding, particularly when discussing alert fatigue, is that alerts in a patient treatment management system are generally thought of as often unwelcome pop-up boxes on a healthcare worker's screen that disrupts their workflow and brings to their attention events or information that they don't necessarily consider important. In some cases they become so onerous that non-technical users of the system request the designers to build the system without any alerts. While in many instances this is an understandable view of alerts, having such a narrow definition prevents the insight necessary to solve the problem of alert fatigue. To effectively manage alerts in a patient treatment management system requires a broader, information technology based definition.

Basic definition—We need to start with some basic definitions and a brief discussion of systems theory. Systems are designed to react to events in the outside world. In fact, system behavior can be defined by describing how the system will react to events. Of course there will be many events about which the system does not care or react. The ones the system cares about are the ones that are said to “cross the system boundary”. That simply means that the system has been defined to detect certain events and provide a response to them. For example, a sick or injured patient walking through the emergency room door is an event to which a hospital system will react.

Any system has components or “parts”. Many of these system components are designed specifically to react to particular events. When an event crosses the system boundary, the system component that detects the event must decide what system component will react to or “process” the event. Think of it as triage. If one patient walking through the door is complaining of a headache and fever and another is bleeding profusely, the system will react differently based on the type of event. If it detects event A it will display one behavior while event B will elicit another response. To implement this, the detecting component must send a message to the system component that will process that particular type of event. That message is called an alert. The recipient of the alert will be an information processor. The processor may be computer software or a person. In either case, the message is still an alert. This event/alert/response is effectively the definition of the system. It is not possible to have a system without alerts.

In almost all cases, there will be a time delay between when an event is detected and when the appropriate processor can react to the event. The length of the time delay is a system design parameter chosen based on the priority of the event being handled. When the detecting component sends the alert, it will typically be held in a message queue until the processing component has time to process it. Think of it as a waiting room for alerts. Every processor will have a queue in front of it. The system designer is responsible for balancing the queue size and processing capacity so the events are processed in a timely fashion. For example, the system designer must ensure that the queue for a profusely bleeding patient is much shorter than the queue for the headache/fever.

Not all events that are detected will be external to the system. During the processing of an event, other events may be detected that change the processing of the original event. For example, an abnormal test result may cause a change to the treatment plan. These events would also result in alerts that should be directed to a processor for that particular event.

Alert overload—Alert overload is exactly what it sounds like. Events are arriving faster than the processor can process them. (The message queues holding the alerts are growing rapidly and approaching the queue capacity.) If the arriving events are crossing the system boundary (i.e., they are not internal events), there are only two possible responses. The system processing power must be increased or a way must be found to reduce the number of incoming events. For example, consider a disaster situation. Massive casualties are pouring into a hospital that quickly approaches capacity. The first reaction is to call in all available staff to increase processing capabilities. Since the hospital has no ability to stop the disaster, a standalone hospital system could do nothing else. The good news is that in most instances, the hospital system is actually a subsystem of a larger healthcare system. At that point, the hospital notifies first responders that they have reached capacity and that all additional casualties (“events”) should be transported to another hospital. Obviously this is not a desirable steady-state. At this point, one can only hope that the casualties that can't be treated at the first hospital will arrive in another facility in time to be treated.

One of the keys in this example is that the hospital system recognized the overload event and reacted to it. Without this key design feature, casualties would′ve piled up in the parking lot. The same design feature should be in place anytime there is a reasonable prospect of alert overload.

Alert fatigue—“Alert fatigue” isn't really a systems term. The phrase is an emotional reaction to alert overload when the message queue that is overflowing is being processed by a human processor. In the vast majority of cases, this occurs not because of understaffing (insufficient processing power) but rather because the internal alert has been misdirected. Alerts should only be sent to “processors” (human or machine) that should provide the system's reaction to the event.

Consider the following example. Assume the hospital has a standard practice of not leaving an IV in the same location for more than seven days. Further assume that the system is capable of detecting an event when the IV has been in the same location for more than seven days. At most, it should issue an alert to the healthcare worker responsible for moving the IV as a reminder. No one else needs to receive the alert. Sending it to someone else that would not act on it themselves simply clogs their message queue obscuring higher priority alerts. If the IV still has not been moved after eight days (a different event), a second alert might be generated to a supervisor that would be expected to take action to protect the patient. The key design feature is to send alerts only to the processor that should process the event. Don't send alerts for informational purposes or simply to suggest what may or may not be a better way for a healthcare worker to perform a task.

If alert fatigue is occurring, it is clearly a sign of system failure. Either alerts are being sent to the wrong location or the system was designed with insufficient processing power/staffing. Like the disaster example, this case of alert overload should also be detected and managed. A method for doing this is described below. Like the disaster example, it does not create a desirable steady-state condition but it will buy time to correct the underlying problem.

Systems that don't use alerts—All systems use alerts by definition. If a software vendor tells you that their product does not use alerts, they are either giving you a sales fabrication or they don't understand systems theory. If they go so far as to create a work plan for healthcare worker, they are using alerts because the work plan in and of itself is an alert. In any case, proceed with caution. What they're really saying is there are one or more classes of events to which their system has been designed not to react. The key to understanding what they are selling is often to understand what events that you as the system owner consider important that their software will ignore. Quite often, the events that they have chosen to ignore are exactly those required for continuous process improvement of the treatment delivery process.

### BRIEF SUMMARY OF THE INVENTION

According to the present invention, the method and the system described here represents an extension to Ashbec's proprietary Treatment Optimization for Patient Safety (TOPS®) method and system as described in U.S. Pat. No. 7,765,114. U.S. Pat. No. 7,765,114 B2 is incorporated herein by reference. This method and system can also be applied to managing alerts for any patient treatment management system that issues alerts for continuous process improvement.

Creating or modifying an alert—The heart of any patient treatment management system is the treatment regimen. It is a standardized, predictable and repeatable process used as a template to create a patient specific treatment plan. Each step in the treatment regimen represents a work task performed by a healthcare worker. Associated with each step will be a set of conditions that would cause the system to trigger an alert. The alert might be issued if the step is not completed in a timely fashion or if the step resulted in an adverse outcome (e.g., test results or vital signs out of range).

The healthcare worker responsible for the design of the alerts associated with these steps must take into account what healthcare workers (or types of healthcare worker) should respond to the alert. The alert should be defined in such a way that only those workers receive the alert. The designer should also have the ability to suspend the issuing of some alerts. The information associated with an alert that has been suspended is not lost. It will be captured by the automated system for subsequent analysis. Not all alerts are appropriate candidates for suspension. For example, while it may be appropriate to initially suspend alerts related to tasks not completed on time until the cause is determined and a solution is put in place, alerts related to “vital signs out of range” should never be suspended. In the preferred implementation, the designer will have the ability to flag an alert as one that should never be suspended as well as flagging alerts as suspended in the current treatment regimen.

The definition of the alert should also include the maximum number of outstanding alerts issued to a particular healthcare worker before the next alert issued to that worker results in triggering an information overload alert. When that maximum is exceeded, and alert overload alert will be issued only to the analyst in charge of CPI.

In the preferred implementation, the designer should also be able to specify a frequency which, if exceeded, would cause the system to automatically suspend an alert which has been defined as one which can be suspended. The actual frequency may be dependent on the size of the organization in which the treatment regimen is being used and should be controlled by the treatment regimen designer.

The designer must also anticipate how groups of alerts can be categorized for batch analysis. The purpose of the analysis will be to identify a group of alerts that are being issued too frequently, perform a root cause analysis to determine why they are being issued so frequently and lastly, what steps need to be taken to improve the quality of the treatment delivery and reduce the frequency of the alerts. To facilitate this, the system should allow the designer to identify the type of alert being defined. While there will be many common types, the designer must have complete flexibility to define whatever type they feel will be useful in the analysis.

Alert triggers—Manual Alerts—In most cases the triggering event and how it will be detected will be defined for a particular alert definition. However, healthcare workers reviewing a treatment plan may notice a problem in the plan that will require one or more other people on the healthcare team to adjust the plan and their activities. In a preferred implementation, the alert management system should provide healthcare workers with the ability to manually trigger an alert in such a circumstance. In such an instance, the “healthcare worker assigned to the task” would be the healthcare worker that triggered the alert.

Alert overload triggers—Alert overload triggers will normally be the result of the number of outstanding alerts for particular healthcare worker exceeding the defined limits. In a preferred implementation, alert overloads could also be triggered based on the frequency of alerts for a particular department or the hospital as a whole.

### BRIEF DESCRIPTION OF THE SEVERAL VIEWS OF THE DRAWING

The above as well as other advantages of the invention will become readily apparent to those skilled in the art from the following detailed description of a preferred embodiment when considered in the light of the accompanying drawings in which:

FIG. 1 is a block diagram showing the connections between components of the treatment management system corresponding to FIG. 6 in U.S. Pat. No. 7,765,114 B2;

FIG. 2 shows a flow diagram of a method of creating and modifying alerts according to the invention; and

FIG. 3A and FIG. 3B show a flow diagram of a method according to the invention for issuing the alerts created by the method shown in FIG. 2.

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

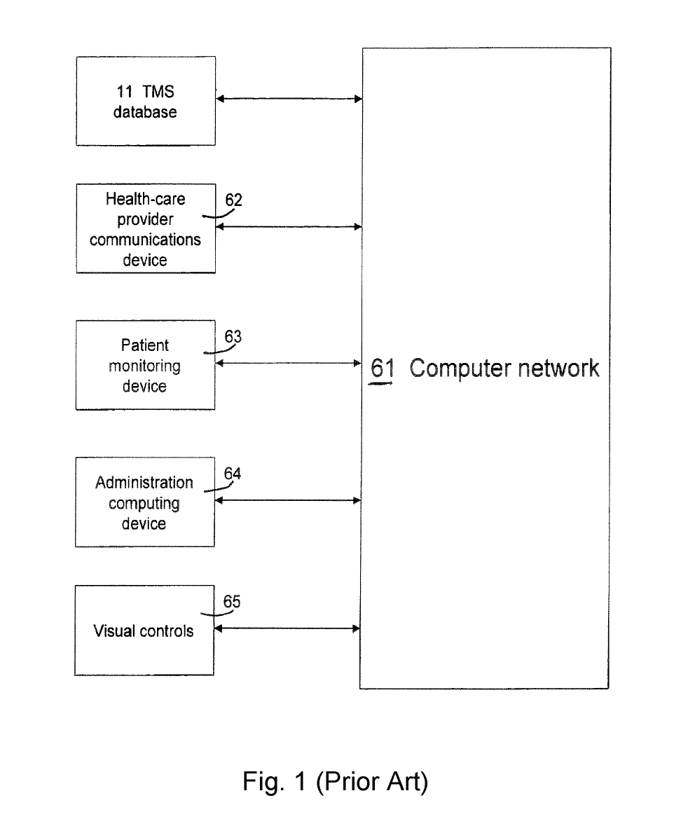

FIG. 1 is a block diagram showing the connections between the components of a medical treatment management system (TMS). A network 60 includes a TMS database 11 connected for data exchange with at least one computer 61. The computer 61 runs software that performs all of the data storage and retrieval associated with the database 11 as described in U.S. Pat. No. 7,765,114 B2. A healthcare provider terminal 62 represents multiple input/output devices of various types utilized by doctors, nurses, lab technicians, etc. to exchange data with the computer 61. A monitoring device 63 represents various medical devices used in the treatment regimen that exchange data with the computer 61. An administration terminal 64 represents one or more input/output devices of various types utilized by hospital administrators, managers, etc. to exchange data with the computer 61. A visual controls block 65 represents the devices that exchange data with the computer 61.

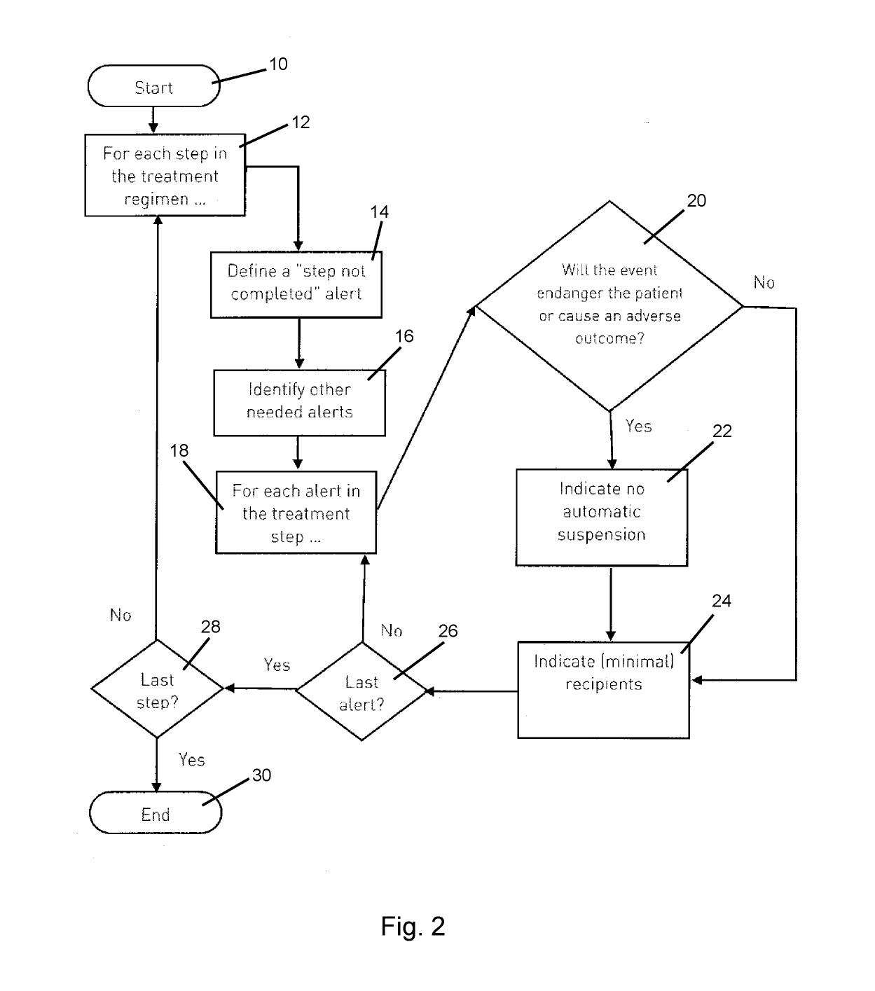

FIG. 2 shows a flow diagram of a method of creating and modifying alerts according to the invention. The method begins at “Start” 10 and enters an instruction step 12 that selects one-by-one each step in the treatment regimen for which alerts are being created and/or modified. The method then enters an instruction step 14 that defines a “step not completed” alert for the current regimen step. Next, the method enters an instruction step 16 that identifies any other needed alerts. In an instruction step 18, the method processes each of the alerts related to the current treatment regimen step by entering a decision step 20. The step 20 determines whether the event represented by the alert endangers the patient or causes an adverse outcome. If “Yes”, the method branches to an instruction step 22 and if “No”, the method branches to an instruction step 24.

In the step 22, the method indicates that there is no automatic suspension of the alert. In the step 24, the method indicates the “minimal” recipients for the alert. The method checks for the last alert in a decision step 26. If “No”, the method returns to the step 18 to process the next alert. If “Yes”, the method checks for the last step in the treatment regimen in a decision step 28. If “No”, the method returns to the step 12. If “yes”, the method exits at “End” 30.

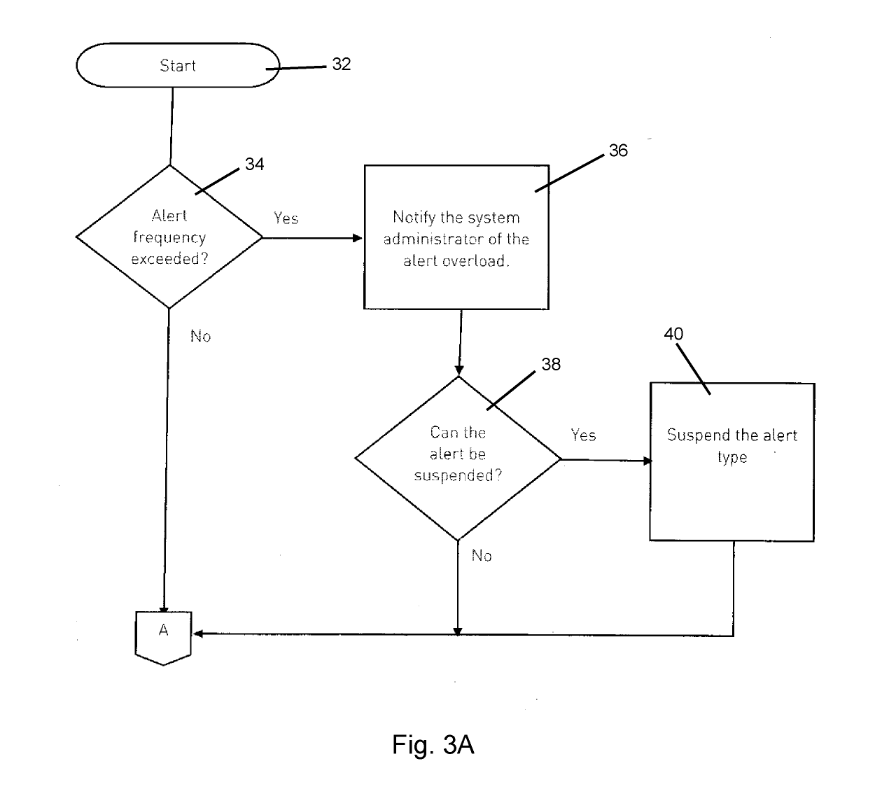

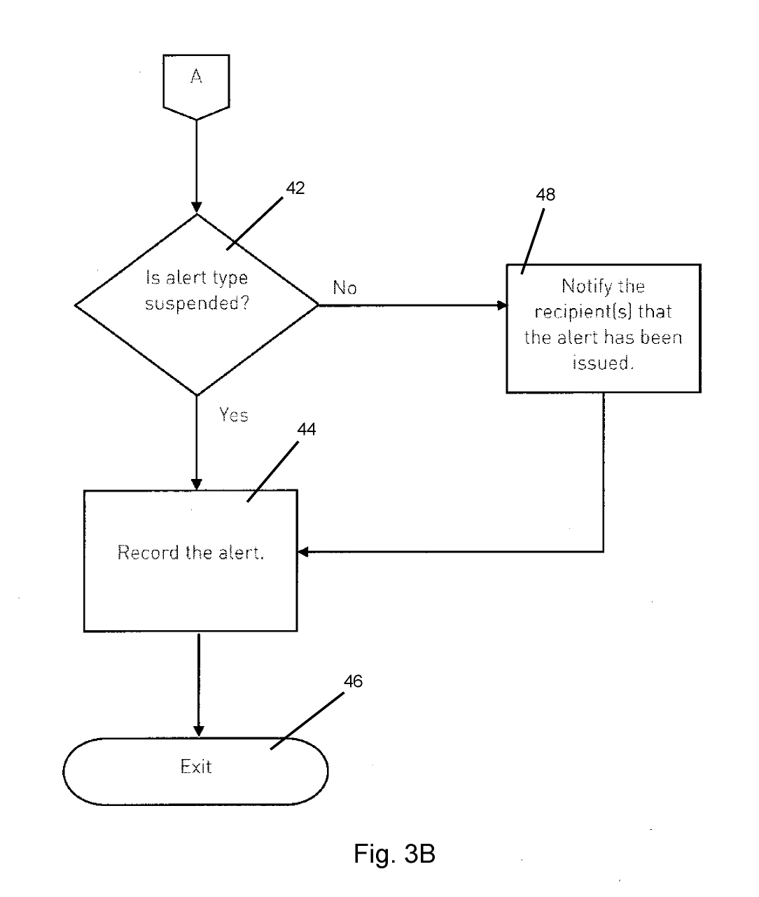

Processing an alert—Under the approach described above, the processing of a triggered alert will be changed as explained in following with reference to FIG. 3A and FIG. 3B. The method begins in FIG. 3A at “Start” 32 and enters a decision step 34 wherein it is determined whether the alert frequency has been exceeded. If the alert frequency for this alert type has been exceeded, or the maximum number of outstanding alerts for this healthcare worker has been exceeded, the method branches at “Yes” to an instruction step 36. In the step 36, the method notifies the system administrator of the alert overload.

The method then enters a decision step 38 to determine whether this type of alert can be suspended. If “Yes”, the method enters an instruction step 40 to suspend the alert type in this treatment regimen for the worker, department or hospital. If the alert type cannot be suspended, the method branches from the decision step 38 at “No” to FIG. 3B at “A” and the alert recipients are notified. Also, if the alert frequency is not exceeded in the decision step 34, the method branches at “No” to FIG. 3B at “A”.

In FIG. 3B, the method enters a decision step 42 to determine whether the alert type is suspended. If “Yes”, the alert is recorded in an instruction step 44. The record of the alert can include: 1) Alert type; 2) Date and time of the alert; 3) Treatment plan; 4) Treatment step; and 5) Healthcare worker assigned (at the time the alert was issued). Other information can be included in the record as desired. The method then ends at “Exit” 46.

If the alert type is not suspended, the method branches from the decision step 42 at “No” to an instruction step 48. In the step 48, the recipients are notified that the alert has been issued. The method then ends at “Exit” 46.

It may also be desirable to allow this process to generate its own alert under one particular circumstance. If the alert frequency for this type of alert has been exceeded (Step 34 at “Yes”) and the treatment regimen designer has indicated that this alert can NOT be suspended, there is an indication of a serious problem. In such a circumstance it may be desirable to alert the treatment regimen designer themselves.

Batch analysis of the alerts—The healthcare worker responsible for maintaining the treatment regimen design as well as others involved in the continuous process improvement effort will need to review the recorded alerts on a regular basis. At a minimum, they will need automated tools capable of sorting the recorded data. This will allow them to cross tabulate the alerts by treatment regimen and alert type. They may also wish to examine other characteristics of the alert such as time of day, type of healthcare worker assigned, particular healthcare worker assigned, etc. The intent is to identify patterns in the data that indicate that there may be a common cause of all of the alerts of a particular type. If no pattern is discernible, it may be necessary to redefine the alert types to test theories regarding possible patterns.

In addition to tracking alerts specific to a particular healthcare worker, the continuous process improvement team will also need to track alert frequency at the department and hospital level. While this information can be collected by the alert management system, much of it will already be available via the billing system. For example, each person admitted to the hospital through the emergency room will constitute an event. Each patient treated by a particular department will constitute an event. When the frequency of these events begins to reach the processing capacity of the department involved, the CPI team should investigate to determine if additional resources are required, if there is a seasonal impact indicating that the spike in patients is temporary or some other reason is apparent that is causing the system to reach capacity.

Once a pattern has been identified, root cause analysis proceeds as it would with a single alert. The most straightforward method will usually be the “five whys” approach taken from lean manufacturing. This should result in the identification of one or more actions to be taken to prevent these alerts from occurring again and improve the quality of the treatment being delivered. Once these steps (including changes to the treatment regimen, if any) are put in place, the designer will decide whether to suspend or activate the particular alert type moving forward. If the designer is confident that the number of alerts being issued will be manageable by the recipients, the alerts should be activated.

Expected results—In many EMR implementations, there is no monitoring of treatment plan versus actual. Those implementations can't actually be considered patient treatment management systems since nothing is being managed. In other implementations, alerts have been initially attempted but poor design and management have resulted in alert fatigue. The resulting backlash from users of the system has often caused alerts to be abandoned. In such implementations, analysis of adverse events after the fact will often result in process improvement in the treatment planning process but no improvement in the treatment delivery process. If the system described above is used effectively, the results should be a dramatic increase in the quality of treatment delivery and a dramatic reduction in medical error, mortality rates and readmission rates.

In hospitals where reimbursement is per capita based or where the hospital is affiliated with an insurance provider whose profit is based on cost per capita, profit margins for both organizations should be dramatically improved. Hospitals still on a fee-for-service-based model may see a reduction in demand for their services initially until the improved quality of patient care increases their market share within their community. Even those hospitals will see an improved negotiating position vis-à-vis the insurance providers pressuring them to reduce costs.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method for processing a triggered alert associated with an occurrence of an event in a patient treatment management system comprising the steps of:
determining an alert type for the triggered alert and an alert frequency for the alert type;
if the alert frequency for the alert type has been exceeded by the triggered alert and the alert type is permitted to be suspended, suspend issuing alerts of the alert type; and
if the alert type is not suspended, notify recipients associated with the alert type of the triggered alert.

2. The method according to claim 1 including a step of notifying an administrator of an alert overload when the alert frequency is exceeded.

3. The method according to claim 1 including a step of creating a record of information associated with the triggered alert.

4. The method according to claim 3 wherein the information includes at least one of the alert type, a treatment plan, a treatment step and an assigned healthcare worker.

5. The method according to claim 1 including creating alerts for a medical treatment regimen having at least one treatment step further comprising the steps of: defining a “step not completed” alert triggered by an event of the at least one treatment step not being completed; identifying any other alerts required to be triggered for events associated with the at least one treatment step; determining for each of the at least one treatment step alerts whether an associated one of the events will endanger a patient or cause an adverse outcome; and indicating no automatic suspension of any of the at least one treatment step alerts if the associated one of the events will endanger a patient or cause an adverse outcome.

6. The method according to claim 5 including a step of indicating recipients for each of the at least one treatment step alerts.

7. The method according to claim 5 wherein the medical treatment regimen includes a plurality of other treatment steps and including a step of ending the creation of the alerts after the alerts for all of the treatment steps have been created.

8. A method for creating alerts for a medical treatment regimen having at least one treatment step comprising the steps of: defining a “step not completed” alert triggered by an event of the at least one treatment step not being completed; identifying any other alerts required to be triggered for events associated with the at least one treatment step; determining for each of the at least one treatment step alerts whether an associated one of the events will endanger a patient or cause an adverse outcome; and indicating no automatic suspension of any of the at least one treatment step alerts if the associated one of the events will endanger a patient or cause an adverse outcome.

9. The method according to claim 8 including a step of indicating recipients for each of the at least one treatment step alerts.

10. The method according to claim 8 wherein the medical treatment regimen includes a plurality of other treatment steps and including a step of ending the creation of the alerts after the alerts for all of the treatment steps have been created.

11. The method according to claim 8 including processing a triggered one of the alerts comprising the steps of:
determining an alert type for the triggered alert and an alert frequency for the alert type;
if the alert frequency for the alert type has been exceeded by the triggered alert and the alert type is permitted to be suspended, suspend issuing alerts of the alert type; and
if the alert type is not suspended, notify recipients associated with the alert type of the triggered alert.

12. The method according to claim 11 including a step of notifying an administrator of an alert overload when the alert frequency is exceeded.

13. The method according to claim 11 including a step of creating a record of information associated with the triggered alert.

14. The method according to claim 13 wherein the information includes at least one of the alert type, a treatment plan, a treatment step and an assigned healthcare worker.

15. A patient management system for processing a triggered alert from medical treatment regimen comprising: a computer network running a software program collecting data from a medical treatment regimen being performed on a patient, the computer network issuing a triggered alert from the data when an associated event has occurred; the computer network determining an alert type for the triggered alert and an alert frequency for the alert type; if the alert frequency for the alert type has been exceeded by the triggered alert and the alert type is permitted to be suspended, the computer network suspend issuing alerts of the alert type; and if the alert type is not suspended, the computer network notifies recipients associated with the alert type of the triggered alert.

16. The system according to claim 15 wherein the computer network notifies an administrator of an alert overload when the alert frequency is exceeded.

17. The system according to claim 15 wherein the computer network creates and stores a record of information associated with the triggered alert.

18. The system according to claim 17 wherein the information includes at least one of the alert type, a treatment plan, a treatment step and an assigned healthcare worker.

19. The system according to claim 15 wherein the computer network creates the alerts for treatment steps of the medical treatment regimen by: defining a “step not completed” alert triggered by an event of each of the treatment steps not being completed; identifying any other alerts required to be triggered for events associated with the treatment steps; determining for each of the treatment step alerts whether an associated one of the events will endanger a patient or cause an adverse outcome; and indicating no automatic suspension of any of the treatment step alerts if the associated one of the events will endanger a patient or cause an adverse outcome.

20. The system according to claim 19 wherein the computer network indicates recipients for each of the treatment step alerts.
